(19) United States
(12) Patent Application Publication
(10) Pub. No.: US 2025/0158191 A1
(43) Pub. Date: May 15, 2025

(54) BATTERY PACK ASSEMBLY

(71) Applicant: Advik Technologies Limited, Sittingbourne (GB)

(72) Inventor: Carlton CUMMINS, Birmingham (GB)

(21) Appl. No.: 18/726,021

(22) PCT Filed: Apr. 7, 2022
(86) PCT No.: PCT/GB2022/050878

§ 371 Date: Jul. 1, 2024

(30) Foreign Application Priority Data
Apr. 7, 2021 (GB) 2104959.8

(51) Int. Cl. H01M 50/213; H01M 50/503

(52) U.S. Cl. CPC H01M 50/213; H01M 50/503

(57) ABSTRACT

A holding frame for use in manufacturing a battery pack assembly, the holding frame comprises a first major surface and a second major surface, on one or both of the first major surface and a second major surface the holding frame having one or more cell-locating structures which are shaped and/or sized and/or configured to accommodate at least a portion of one or more cells, the one or more cell-locating structures comprising a first wall upstanding from one of the first or second major surfaces, the first upstanding wall comprising a first portion extending from the first or second major surface and a free or terminal portion which is shaped to provide a lead-in portion terminating at a distal end, the free or terminal portion providing a minor portion of the upstanding wall and the holding frame extending from the first major surface to the distal end.

This invention relates generally to a battery pack assembly. More specifically, although not exclusively, this invention relates to a holding frame for use in a battery pack assembly, for example, a lithium-ion battery pack assembly e.g. a large format battery pack assembly, methods of making the same, and uses of the same.

Lithium-ion batteries are known in a variety of cell formats, wherein cylindrical, prismatic and pouch cells are the most common varieties. In a cylindrical cell the electrode is tightly wound about itself and the terminals are typically found at either end of the cylinder, the electrode being contained within a casing, typically made from aluminium or steel. Due to the shape of the cell, packing efficiency may be low but the provision of spaces between adjacent cells is useful for thermal management purposes. The electrodes of prismatic cells can be wound, stacked or folded and are usually located within an aluminium or plastics housing. The terminals are often on one end of the cell which, coupled with the shape of the cell improves packing efficiency. Pouch cells typically have stacked or folded electrodes encased in a flexible plastics casing. The terminals of pouch cells may extend from different sides of the pouch but conveniently they may both extend from one side, for example the top, of the pouch.

It is known to connect lithium-ion batteries or cells in series and/or parallel to increase the voltage to produce a “large format battery pack”. These offer several benefits including high energy density in comparison to their weight, high operating voltage and slow self-discharge. Consequently, large format battery packs of this type find use in a range of both consumer and industrial applications including as emergency power back-up, vehicle power, and solar power storage.

There appears to be no set definition of what constitutes a “large format battery pack”. The UN, for example (e.g. in relation to the UN38.3 Procedure), states that a ‘large battery’ is one that has a mass in excess of 12 kg whereas some manufacturers specify that large batteries or large format battery packs have an energy storage in excess of 1 kWh. For the purposes of this invention we consider that a large format battery pack is one with more than three cells (be they cylindrical, prismatic or pouch) connected, for example in parallel or series and in some cases have more than 6, 9 or 12 connected cells, for example 48, 96, 64, 128 cells.

Large format battery packs using cylindrical cells often have a plurality of cells, typically or more cells, electrically connected and presented as a single unit called a battery module. In industry, these modules are typically assembled using permanent assembly techniques (structural adhesives, spot welding, soldering etc.). Such permanent assembly techniques present challenges for repairing or reusing the modules (or the cells or other parts thereof), as the individual components of the assembly cannot easily be accessed or removed. This also makes it difficult to recycle the modules, as the various materials cannot easily be separated.

Accordingly, such production techniques can lead to energy storage products which are not aligned with EU waste management legislations and prohibits greater revenue opportunities in the repair and repurposing of batteries and battery modules.

In our earlier patent application WO2020/128532, we describe a battery pack assembly that aims to solve this problem. The battery pack assembly comprises a first and second holding frame, a plurality of cells having terminals at each end thereof, fastening means for reversibly holding the first and second holding frames with respect to one another in a closed condition, an electrically conductive conductor plate for providing electrical contact to at least two of said plurality of cells, the conductor plate having respective protrusions for making contact with each of said at least two cells, the first holding frame bearing directly against said conductor plate to cause the protrusions of the conductor plate to make electrical contact with said at least two cells in said closed condition.

In our earlier patent application WO2020/128533, we describe another battery pack assembly that aims to solve the aforementioned problem. The battery pack assembly comprises a first and second holding frame for holding a plurality of cells therebetween, a conductor for engaging the plurality of cells and having at least a first contact for engaging a first cell terminal and a second contact for engaging a second cell terminal, a resilient member being located between the conductor and one of the first or second holding frame to bear against the conductor adjacent the first contact and second contact.

The inventions described in these patent applications are effective for enabling rapid assembly and disassembly of the battery pack assembly for the recycling and reuse of cells within large format battery packs.

A first non-exclusive object of the invention is to provide a component, e.g. a holding frame, for use in assembling a battery pack assembly, e.g. a large format battery pack assembly, that is configured such that the components can be even more readily assembled during manufacturing.

Accordingly, a first aspect of the invention provides a holding frame for use in manufacturing a battery pack assembly, the holding frame having a first major surface and a second major surface, on one or both of the first major surface and the second major surface the holding frame having one or more cell-locating structures which are shaped and/or sized and/or configured to accommodate at least a portion of one or more cells, the one or more cell-locating structures comprising a first wall upstanding from one of the first or second major surfaces, the first upstanding wall comprising a free or terminal portion which is shaped to provide a lead-in portion.

The at least one cell-locating structure may comprise one first upstanding wall or more than one upstanding wall, e.g. a second, third, or n^{th} upstanding wall. The at least one cell-locating structure may comprise two, three, four, five, six, or plural further upstanding walls. The one and/or second and/or plural upstanding walls may at least partially define a cell-locating zone on the frame.

The one or more upstanding wall(s) may each comprise a terminal edge shaped to provide a lead-in portion.

Advantageously, the holding frame may comprise an array of upstanding walls providing cell-locating structures. At least some of the array of upstanding walls may cooperate to provide one or more cell-locating structures.

The or each upstanding wall may extend from a base portion, adjacent the major surface from which the upstanding wall extends, to a terminal edge.

The first upstanding wall may be associated with a first cell-locating zone, the second upstanding wall may be associated with a second cell-locating zone, the third or plural upstanding wall may be associated with a third or n^{th} cell-locating zone.

The cell-locating structure may comprise a single upstanding wall arranged to completely or substantially bound a cell locating zone. Alternatively, each cell-locating structure may comprise plural, e.g. two, three, or four, upstanding walls to provide a discontinuous boundary about the or a cell-locating zone. The provision of plural upstanding walls which together provide a discontinuous boundary about the or a cell-locating zone may be preferable for weight and thermal management reasons.

One or more or each of the second or further upstanding walls may each comprise a terminal portion which is shaped to provide a lead-in portion. One or more of the second or plural further upstanding walls may comprise a terminal portion which is shaped to provide a lead-in portion.

The frame has a periphery. A peripheral wall may be provided, for example extending from one or both of the first major surface and the second major surface. The at least one cell-locating structure may be located inboard of the periphery.

Advantageously, the holding frame according to the invention enables a battery pack assembly to be rapidly and efficiently assembled without having to perfectly align the axis of each cell. For example, where plural cells are loaded onto the frame in a single operation, the provision of the lead-in portion allows the fast and efficient location of the cells without the cells being perfectly axially aligned. For example, if an array of 24 (or more) cells are to be loaded onto the frame, for example simultaneously, the provision of cell-locating structures having a lead-in portion will allow the array of cells to be located within respective cell-locating zones without perfect alignment between the principal axis of the cell and the frame. This reduces assembly times of the battery pack assembly by facilitating alignment of the cells with respect to the frame.

The holding frame may be useable as an outer holding frame in a battery pack assembly, or an intermediate holding frame. Where the holding frame is configured for use as an outer holding frame the cell-locating structure(s) are provided on one of the first major surface or the second major surface. Where the holding frame is configured for use as an intermediate holding frame the cell-locating structure(s) are provided on both of the first major surface and the second major surface. In a battery pack assembly the intermediate holding frame is located between two separate arrays of cells, one array adjacent the first major surface the second array adjacent the second major surface.

The or each cell-locating structure may comprise an opening for receipt of a cell.

In embodiments, one or each of the first and second major surface of the holding frame may comprise plural cell-locating structures. In embodiments, one or each major surface the holding frame may comprise two or more cell-locating structures, for example, three, four, five, six, seven, eight, nine, ten, eleven, twelve, thirteen, fourteen, fifteen, sixteen, seventeen, eighteen, nineteen, twenty, or more than twenty cell-locating structures. That is, each major surface of the holding frame may be configured to seat three, four, five, six, seven, eight, nine, ten, eleven, twelve, thirteen, fourteen, fifteen, sixteen, seventeen, eighteen, nineteen, twenty, or more than twenty cells.

The or each cell-locating structure may comprise a first diametrical dimension and a second diametrical dimension at its terminal edge, the second diametrical dimension preferably being larger than the first diametrical dimension, thereby to provide the lead-in portion.

For example, the first diametrical dimension may be the maximum transverse distance across a cell locating zone at a position proximate the first or second major surface from the which cell-locating structure extends. The second diametrical dimension may be the maximum transverse distance across a cell locating zone at a position proximate or at the terminal edge of the upstanding wall.

In embodiments, the second diametrical dimension may be greater than 1.0 and less than or equal to 1.5 times larger than the first diametrical dimension, for example, greater than 1.0, 1.1, 1.2, 1.3, or 1.4 times, and less than or equal to 1.5, 1.4, 1.3, 1.2, 1.1 times larger than the first diametrical dimension. In embodiments, the second diametrical dimension may be greater than or equal to 1.1 times larger than the first diametrical dimension. In embodiments, the second diametrical dimension may be greater than or equal to 1.2, 1.3, 1.4, or 1.5 times larger than the first diametrical dimension.

In embodiments, the, some or each upstanding wall may comprise a first portion extending from the major surface of the frame and the terminal portion. The first portion may comprise a major proportion of the upstanding wall. The first portion may comprise from 55% to 98% of the upstanding wall, say from 60, 65, 70 or 75% to 98, 97, 96, 95% of the upstanding wall. The terminal portion may comprise a minor proportion of the upstanding wall. The terminal portion may comprise from 45% to 2% of the upstanding wall, for example from 40, 35, 30 or 25% to 2, 3, 4, 5% of the upstanding wall.

The first portion may be perpendicular to the major surface of the frame. The terminal portion may be stepped and/or tapered. In use, a cell may be in contact with or lie adjacent the first portion. In embodiments, the tapered or terminal portion may be angled relative to the axis of the non-tapered or first portion. In embodiments, terminal portion may extend at an angle from the first portion. The angle may be greater than zero and less than 60 degrees, for example, less than 55, 50, 45, 40, 35, 30, 25, 20, 15, 10, or 5 degrees. In embodiments, the angle may be greater than or equal to any one of 0, 5, 10, 15, 20, 25, 30, 35, 40, 45, 50, 55 degrees and less than or equal to any one of 60, 55, 50, 45, 40, 35, 30, 25, 20, 15, 10, 5 degrees. The angle formed by the terminal or tapered portion and the first portion may be greater than or equal to 15 degrees and less than or equal to 50 degrees, for example, greater than or equal to 20 degrees and less than or equal to 45 degrees.

In embodiments, the holding frame may be suitable for manufacturing a battery pack assembly comprising, e.g. shaped to accommodate for example cylindrical cells or prismatic cells.

When the holding frame is suitable for manufacturing a battery pack assembly comprising cylindrical cells, the cell-locating structures may define a circular or substantially circular cell-locating zone. The upstanding wall may comprise a cylindrical or part cylindrical shape. The one or more upstanding walls may together define a cylindrical or part-cylindrical perimeter about a cell-locating zone. For example, the one or more upstanding walls may comprise an upstanding wall having a concave arcuate shape forming a generally cylindrical region to seat a cylindrical cell.

In embodiments, the holding frame may be suitable for manufacturing a battery pack assembly comprising 18650 cylindrical cells having a cell diameter of 18 mm and a cell height of 65 mm. In embodiments, the one or more cell-locating structure may be sized to seat an 18650 cylindrical cell. In embodiments, the first diametrical dimension may be greater than 18 mm and less than 19 mm, e.g. greater than 18 mm and less than 18.5 mm, or less than 18.4 mm, or less than 18.3 mm, or less than 18.2 mm, or less than 18.1 mm.

In embodiments, the holding frame may be suitable for manufacturing a battery pack assembly comprising 21700 cylindrical cells having a cell diameter of 21 mm and a cell height of 70 mm. In embodiments, the first diametrical dimension may be greater than 21 mm and less than 22 mm, e.g. greater than 21 mm and less than 21.5 mm, or less than 21.4 mm, or less than 21.3 mm, or less than 21.2 mm, or less than 21.1 mm.

In embodiments, the holding frame may be suitable for manufacturing a battery pack assembly comprising 26650 cylindrical cells having a cell diameter of 26 mm and a cell height of 65 mm. In embodiments, the first diametrical dimension may be greater than 26 mm and less than 27 mm, e.g. greater than 26 mm and less than 26.5 mm, or less than 26.4 mm, or less than 26.3 mm, or less than 26.2 mm, or less than 26.1 mm.

In embodiments, the holding frame may be suitable for manufacturing a battery pack assembly comprising 32650 cylindrical cells having a cell diameter of 32 mm and a cell height of 65 mm. In embodiments, the first diametrical dimension may be greater than 32 mm and less than 33 mm, e.g. greater than 32 mm and less than 32.5 mm, or less than 32.4 mm, or less than 32.3 mm, or less than 32.2 mm, or less than 32.1 mm

The height of the upstanding wall, may be less than 70 mm, or less than 65 mm, or less than 60 mm, or less than 55 mm, or less than 50 mm, or less than 45 mm, or less than 40 mm, or less than 35 mm, or less than 30 mm, or less than 25 mm, or less than 20 mm, or less than 15 mm, or less than 10 mm. The height of the upstanding wall, may be between 10 to 30 mm, for example, between any one of 10, 11, 12, 13, 14, 15, 16, 17, 18, 19, 20, 21, 22, 23, 24, 25, 26, 27, 28, 29 mm to any one of 30, 29, 28, 27, 26, 25, 24, 23, 22, 21, 20, 19, 18, 17, 16, 15, 14, 13, 12, 11 mm. The height of the upstanding wall may be between 15 to 23 mm, e.g. greater than or equal to any one of 15, 16, 17, 18, 19, 20, 21, 22 mm and less than or equal to any one of 23, 22, 21, 20, 19, 18, 17, 16 mm. The height of the upstanding wall may be between 15 to 23 mm, e.g. from any one of 15, 16, 17, 18, 19, 20, 21, 22 mm to any one of 23, 22, 21, 20, 19, 18, 17, 16 mm.

Advantageously, the height of the upstanding wall may be selected depending on the diameter of the cells for which it is configured to hold. Cells having a smaller diameter require a taller upstanding wall, whereas cells having a relatively larger diameter require a relatively shorter upstanding wall. The upstanding wall may have a total height (orthogonal distance from the adjacent major surface) of from 10 to 30 mm. It has been found that for 18650, 21700, 26650, 32650 cells, a height of between 15-23 mm may be optimal for providing stability to the battery pack assembly, whilst saving on material costs. Thus, a frame configured to house 18650 cells may have a first diametrical dimension of less than 19 mm and a height of upstanding wall of greater than 23 mm (e.g. from 23 to 26 mm) whereas a frame configured to house 32650 cells may have a first diametrical dimension of less than 33 mm and a height of upstanding wall of around 15 mm (e.g. from 13 to 18 mm).

The angle of the terminal portion or tapered portion may be proportional to the first diametrical dimension, the larger the diametrical dimension the greater the angle of the terminal portion with respect to the first portion. For example, smaller cells (e.g. 18650 cells) require a smaller angle, for example, of 20-45 degrees, whereas larger cells (e.g. 32650 cells) require a larger angle, for example, between 45-75 degrees.

The holding frame may be suitable for manufacturing a battery pack assembly comprising lithium ion cells, e.g. cylindrical lithium ion cells, for example 18650, 21700, 26650, 32650 lithium ion cells.

In embodiments, the holding frame may have a thickness of between 2 to 30 mm, e.g. from any one of 2, 3, 4, 5, 6, 7, 8, 9, 10, 11, 12, 13, 14, 15, 16, 17, 18, 19, 20, 21, 22, 23, 24, 25, 26, 27, 28, 29 mm to any one of 30, 29, 28, 27, 26, 25, 24, 23, 22, 21, 20, 19, 18, 17, 16, 15, 14, 13, 12, 11, 10, 9, 8, 7, 6, 5, 4, 3 mm.

In embodiments, the upstanding wall of the one or more cell locating structures may have a thickness of between 1.0 to 2.0 mm, e.g. from any one of 1.0, 1.1, 1.2, 1.3, 1.4, 1.5, 1.6, 1.7, 1.8, 1.9 mm to any one of 2.0, 1.9, 1.8, 1.7, 1.6, 1.5, 1.4, 1.3, 1.2, or 1.1 mm.

In embodiments, the holding frame may be suitable for manufacturing a battery pack assembly comprising, e.g. shaped to accommodate, cells of different shapes other than cylindrical ones, e.g. rectangular or other shapes.

In embodiments, the cell-locating structure(s) of the first surface of the holding frame and the second surface of the holding frame may be dissimilar. In embodiments, the height of the upstanding wall of the one or more cell-locating structure(s) of the first surface of the holding frame may be greater than the height of the upstanding wall of the one or more cell-locating structure(s) of the second surface of the holding frame.

In embodiments, the holding frame may comprise a generally flat base and one or more side walls, e.g. upstanding side walls. In embodiments, the holding frame may comprise a side wall which upstands from the periphery of the base of the one or more, or each, holding frame. The side walls may be facing side walls. In embodiments, one or more or each holding frame may comprise an upstanding side wall which extends around the entire periphery of the base of the one or more, or each, holding frame. In alternative embodiments, the upstanding side wall may extend around a portion of the periphery of the base of the one or more, or each, holding frame. In an embodiment the side wall may be discontinuous. In embodiments in which the holding frame is to be used with cylindrical cells, at least one side wall, and preferably facing side walls, may further comprise a one or more concave arcuate sections complementary to the side wall of the cells to be inserted into the assembly.

In embodiments, one or more of the side walls located at the periphery of the base of the holding frame may have a thickness of between 2.0 to 3.0 mm, e.g. from any one of 2.0, 2.1, 2.2, 2.3, 2.4, 2.5, 2.6, 2.7, 2.8, 2.9 mm to any one of 3.0, 2.9, 2.8, 2.7, 2.6, 2.5, 2.4, 2.3, 2.2, or 2.1 mm.

In embodiments, the holding frame may be configured or shaped to encase the ends of one or more cells, in use. For example, one or more (e.g. each) holding frame may encase a respective end of each cell, in use. In embodiments, one or more of the holding frames (for example, each holding frame) may encase one or more cell terminal(s), e.g. each cell terminal. In an embodiment one or more of the holding frames may comprise cooperating portions inboard of the periphery thereof. The cooperating portions may be shaped to cooperate with and/or correspond to the external periphery of at least a portion of one or more cells.

Advantageously, provision of an upstanding side wall and/or encasing one or more ends or terminals of the cells, in use, provides a more secure battery pack assembly with respect to the plurality of cells. This provides better contact between the conductor and the cell terminals, which is further enhanced by a resilient member, which may be located between the conductor and one or more of the holding frames. This is particularly advantageous when no permanent fastening means (e.g. adhesive) are provided within the battery pack assembly, such that the assembly is rigid and stable in use, but may be readily disassembled into its component parts.

In alternative embodiments, the holding frame may comprise a base portion with no side walls. The holding frame may further comprise a plurality of protrusions extending perpendicularly from the base, for example to delimit or space the adjacent portions of the cells from one another. For example, the walls of the base protrusions may comprise a plurality of concave arcuate sections complementary to the facing portions of the cells to be inserted into the assembly.

The holding frame, e.g. one or both of an outer holding frame, may be or may provide an access lid, which can be opened or removed to gain access to the cells.

In embodiments, the holding frame may be fabricated from an electrically insulative material, for example, a polymer or plastic material. The holding frame may be fabricated using any suitable method, e.g. injection moulding of a suitable material. Suitable materials for fabricating the holding frames include Nylon, PPE (polyphenylene ether), ABS (acrylonitrile butadiene styrene), PA (polyamide), PP (polypropylene), PS (polystyrene). Moulding is a convenient technique because it allows for the formation of the cell locating structures having lead ins, as well as providing for projections which mitigate the stress experienced during compression and/or allows for the fabrication of different floor heights to allow interframe spaces to be varied across a battery pack assembly.

It will be appreciated that for a battery pack assembly in which the cells are retained by compression it is important to maintain compression over the lifetime of the cells. It is also important to ensure that the compression is even across an array of cells to equalise contact resistance between the conductor and the terminals of the cell. Such considerations might lead to an increase in the number of fasteners and/or to an increase in the thickness of the walls of the holding frame. However, both of such measured would increase weight and/or volume which would decrease the mass or volumetric energy density of the battery pack assembly.

We have surprisingly found that it is possible to retain plural cells between facing holding frames in which the number of fasteners is significantly less than the number of cells retained by providing strengthening projections on a major surface of at least one of the holding frames and/or by having variable the inter holding frame gap size for the receipt of cells, the gap size closer to fasteners being greater than the inter holding frame gap size further from the fasteners. These measures allow for even compression forces to be applied whilst minimising weight and volume increases.

A further aspect of the invention provides a battery pack assembly, the assembly comprising a first holding frame and a second holding frame, a plurality of cells having terminals, and an electrically conductive conductor plate for providing electrical contact to at least two of said plurality of cells, the first holding frame having a first major surface and a second major surface, the first major surface having first and second cell-locating structures extending therefrom each of which are shaped and/or sized and/or configured to accommodate at least a portion of one of said plurality of cells, the second holding frame having a first major surface and a second major surface, the first major surface having first and second cell-locating structures extending therefrom each of which are shaped and/or sized and/or configured to accommodate at least a portion of said one of said plurality of cells, the distance between the facing first major surfaces of the first holding frame and the second holding frame being different for the respective first cell locating structures and second cell location structures.

A further aspect of the invention provides a battery pack assembly, the assembly comprising a plurality of cells having terminals at each end thereof, an electrically conductive conductor plate for providing electrical contact to at least two of said plurality of cells, and a holding frame for use in manufacturing a battery pack assembly, the holding frame having a first major surface and a second major surface, on one or both of the first major surface and the second major surface the holding frame having one or more cell-locating structures which are shaped and/or sized and/or configured to accommodate at least a portion of one or more cells, the one or more cell-locating structures comprising a first wall upstanding from one of the first or second major surfaces, the first upstanding wall comprising a free or terminal portion which is shaped to provide a lead-in portion.

In the battery pack assembly of the invention, the electrically conductive conductor plate is located between the holding frame and at least some of the terminals of the plurality of cells.

In embodiments, the battery pack assembly may comprise more than one holding frame, e.g. two, three, four, or more holding frames. Advantageously, the provision of more than one holding frame enables more than two set of cells, e.g. three sets, four sets, five sets or more to be stacked to form the battery pack assembly.

In embodiments, the battery pack assembly may comprise a first outer holding frame and/or a second holding frame.

In embodiments, the battery pack assembly may comprise a first plurality of cells located between the first outer holding frame and the holding frame, and a second plurality of cells located between the holding frame, and a second outer holding frame.

In embodiments, the battery pack assembly comprises a first outer holding frame (F), a first set of cells (C), an intermediate holding frame (F), a second set of cells (C), and a second outer holding frame (F). In embodiments, there may be more than one intermediate holding frame (F), for example, two, three or more intermediate holding frames (F), for example, situated between a first and second outer holding frames, with a plurality of cells situated between each holding frame. In embodiments, the holding frame (F)—cell (C)—holding frame (F) (i.e. FCF) architecture can be repeated plural times to form an FCFCF architecture, or FCFCF . . . CF architecture. In embodiments, the battery pack assembly comprises the architecture FCFCFC . . . F.

Advantageously, this architecture allows plural sets of cells to be stacked in a battery pack assembly.

In embodiments, the battery pack assembly further comprises fastening means or a fastener configured to reversibly hold the first and second outer holding frames with respect to one another in a closed condition.

The fastening means may be any suitable reversible fastening means known to the skilled person. For example, the fastening means may comprise or may consist of a plurality of fastening nuts and/or bolts. Each fastening nut may each thread through a hole in each of the two outer holding frames and act to compress the assembly, encouraging contact between the cells and the conductor.

In embodiments, the battery pack assembly may comprise of a first set of cells positioned between a first outer holding frame and a holding frame, and a second set of cells positioned between a second outer holding frame and the holding frame, the first and second holding frames being in parallel relations, each cell being held longitudinally between the respective holding frame and holding frame by virtue of the fastening means being secured or ‘tightened’ to clamp the cells between the holding frames.

The fastening means or fastener causes terminals of the two cells to be urged against the conductor (and/or vice versa) and removal or loosening of the fastener or fastening means into an disassembled or open configuration enables the cells to be freed from the assembly.

This allows for the complete disassembly of a large format battery pack assembly into its individual components. The ability to completely disassemble the assembly permits the module to be repaired via the replacement of individual cells or other components, allows individual components of the module to be reused for further applications at the end of the useful life of the complete assembly, and allows for improved recycling as each of the individual components of the module can be separated and sorted for recycling accordingly. Further, it also allows for upgrades or replacement of components as may be required over the service life of the assembly.

As well as assisting manufacturers to meet EU waste management legislation, the ability to reuse, repair and recycle individual components of battery modules would also save money and resources for the manufacturers. Individual or multiple cells may be replaced with ease, meaning the assemblies could be repeatedly rebuilt at end of life instead of being disposed. It also presents the opportunity for the reuse of cells from a module in other energy storage applications when they no longer perform in the original module application or when the module is no longer required.

In embodiments, more than one conductor plate may be provided. In embodiments, the one or more conductor plate(s) may comprise one or more cooperating members. In embodiments, the cell-locating structures of the holding frame and the cooperating members of the conductor plate cooperate to ensure that the conductor plate(s) is/are appropriately located or locatable with respect to the holding frame.

In embodiments, the one or more conductor plate(s) may comprise or consist of a sheet comprising one or more apertures. Each aperture may correspond to a respective upstanding wall, e.g. a respective formation. In embodiments, the cell-locating structure(s) of the holding frame may comprise one or more upstanding walls, and the conductor plate may comprise one or more apertures.

In embodiments, the conductor plate may comprise one or more protrusions on a major surface, for example on a first major surface. In embodiments the conductor plate may comprise one or more rebates on a major surface, for example on a second major surface. In an embodiment the conductor plate may comprise a rebate on the second major surface that corresponds to the protrusion the first major surface of the conductor plate.

In embodiments, the conductor plate may have respective protrusions for making contact with each of said at least two cells. In a closed condition of the battery pack assembly, the protrusions of the conductor plate extend towards the cell terminals.

The one or more protrusions may be located between said conductor plate cooperating members. The conductor plate cooperating members may describe a conductor plate cooperating member array. The first and second (e.g. and n^{th}) contact may form a contact array. The contact array and the conductor cooperating member array may be displaced with respect to one another, such that a contact does not overlie a conductor cooperating member.

In embodiments, the holding frame may bear directly against said conductor plate to cause the protrusions of the conductor plate to make electrical contact with a cell terminal in a closed condition. Advantageously, in embodiments wherein the conductor plate of the battery pack assembly is provided with one or more protrusions, each protrusion is configured to contact the one or more cell terminals.

Advantageously, the protrusions aid electrical contact to be made between the one or more conductor plates and the cell terminals. In a closed condition of the battery pack assembly, the protrusions of the conductor plate extend towards the cell terminals. The protrusions of the conductor plate may be urged into contact with the cell terminals by tightening the fastening means, which provides effective electrical contact between the conductor and the cell terminals, when the battery pack assembly is in use. This prevents failure and/or disconnection of the cell terminals from the conductor.

It has been surprisingly found that said fastening means or fasteners are capable of generating sufficient compressive force to urge the protrusions of the conductive means into contact with the cell terminals for electrical connection. It has been further surprisingly found that quality electrical contacts are maintained even when the assembly undergoes vibration.

Advantageously, the battery pack assembly of the present invention comprises fewer components, which enables rapid assembly and disassembly, and ease of manufacture. Furthermore, the provision of elastomeric protrusions on one or more holding frames may be avoided, which is advantageous from a manufacturing perspective.

The second major surface of the outer holding frame may comprise an array of formations, e.g. projections, configured to distribute the compressive force applied by the fastening means across the second surface of the outer holding frame.

In this way the number of fasteners used may be decreased. For example when the plurality of cells are located in columns and rows the number of fasteners (B) may be less than the number of cells (C×R) according to the following formula:

$$1 \leq B \leq ( ( {C}_{C} - 1 ) . ( {C}_{R} - 1 ) ) - 1$$

Where C_{C} is the number of cells in each column and C_{R} is the number of cells in each row.

In embodiments the surface, e.g. the second major surface of the outer holding frame may be shaped to allow for an even compressive force across the whole battery assembly. For example, the space for accommodating cells between facing portions of facing holding frames may be different in different portions of the holding frame. For example the space (or gap size) may be defined between a holding frame and a second holding frame for accommodating cells may vary. The gap sizes closer to the apertures for receipt of fasteners may be larger than the gap sizes further from the apertures, to mitigate the increased effective clamping force experienced closer to the fasteners in use.

A further aspect of the invention provides a battery pack assembly, the assembly comprising a plurality of cells having terminals, an electrically conductive conductor plate for providing electrical contact to at least two of said plurality of cells, an outer holding frame, and reversible fastening means or a fastener configured to apply a compressive force to urge the terminals of the plurality of cells, the conductive conductor plate, and the outer holding frame into contact, wherein the outer holding frame has a first major surface and a second major surface, the first major surface of the outer holding frame may have one or more cell-locating structures which are shaped and/or sized and/or configured to accommodate at least a portion of one or more cells, the second major surface of the outer holding frame comprises an array of formations, e.g. projections, configured to distribute the compressive force applied by the fastening means across the second surface of the outer holding frame.

In the battery pack assembly of the invention, the electrically conductive conductor plate is located between the outer holding frame and at least some of the terminals of the plurality of cells.

The fastening means or fastener causes terminals of the two cells to be urged against the conductor (and/or vice versa) and removal or loosening of the fastener or fastening means into an disassembled or open configuration enables the cells to be freed from the assembly.

The fastening means or fastener may be any suitable reversible fastening means known to the skilled person. For example, the fastening means may comprise or may consist of a plurality of fastening nuts and/or bolts. Each fastening nut may each thread through a hole in each of the two outer holding frames and act to compress the assembly, encouraging contact between the cells and the conductor.

The battery pack assembly of the invention is configured such that the compressive force applied by the fastening means is distributed across the surface of the outer holding frame. Advantageously, this reduces the number of required compression points, and therefore the number of fasteners, e.g. nuts and bolts, required to urge the terminals of the plurality of cell, the conductive conductor plate, and the outer holding frame into contact. Advantageously, a battery pack assembly comprising fewer fasteners is more efficiently assembled and disassembled.

The number of cells C retained by a holding frame may be related to the number of fasteners (B) by the following formula:

$$1 \leq B \leq \frac{{C}_{C} . {C}_{R}}{4}$$

For example, an 8×8 array of cells C may be secured by a 3×3 array of fasteners B.

In embodiments, the one or more cell-locating structures located on the first major surface of the holding frame may comprise a first wall upstanding from the first major surfaces. In embodiments, the first upstanding wall may comprise a free or terminal portion which is shaped to provide a lead-in portion.

In embodiments, the battery pack assembly may comprise more than one outer holding frame, e.g. a first and a second outer holding frame. In embodiments, the first and second outer holding frame may each comprise a first major surface and a second major surface, the first major surface having one or more cell-locating structures which are shaped and/or sized and/or configured to accommodate at least a portion of one or more cells, the second major surface comprising an array of projections configured to distribute the compressive force applied by the fastening means across the second surface.

In embodiments, the battery pack assembly may further comprise one or more intermediate holding frame(s), the intermediate holding frame for locating between a first plurality of cells and a second plurality of cell. Advantageously, the provision of more than one intermediate holding frame enables more than two set of cells, e.g. three sets, four sets, five sets or more to be stacked to form the battery pack assembly.

In embodiments, the intermediate holding frame may comprise one or more cell-locating structures located on one or both of the first and second major surface of the intermediate holding frame. In embodiments, the one or more cell-locating structures may comprise a first wall upstanding from the first or second major surfaces. In embodiments, the first upstanding wall may comprise a free or terminal portion which is shaped to provide a lead-in portion.

In embodiments, the outer and/or intermediate holding frame(s) may each comprise one or more apertures for receiving one or more fastening means or fasteners. In embodiments, the outer and/or intermediate holding frame(s) may each comprise n apertures for receiving n fastening means or fasteners. For example, the outer and/or intermediate holding frame(s) may comprise two, three, four, five, six, seven, eight, nine, or more apertures for receiving one or more fastening means or fasteners.

In an embodiment, the outer holding frame comprises nine apertures for receiving nine fastening means or fasteners, e.g. nine bolts.

It has been surprisingly found that the battery packs of the invention can be effectively formed with very few components, for example a battery pack comprising 128 cells can be formed using as few as 9 compression bolts.

The second surface of the outer holding frame is the outwardly facing surface.

In embodiments, array of projections configured to distribute the compressive force applied by the fastening means across the second surface may comprise an array of upstanding walls on the second surface of the outer holding frame.

In embodiments, the array of projections (e.g. the array of upstanding walls) may comprise one or more set(s) of concentric circles. A set of concentric circles may surround an aperture for receiving one or more fastening means or fasteners, e.g. wherein the aperture may be located in the centre of innermost circle of each set. A set of concentric circles may comprise two, three, four, or more concentric circles, e.g. surrounding an aperture for receiving one or more fastening means or fasteners.

In embodiments, the outer holding frame may comprise n apertures for receiving one or more fastening means or fasteners, and the array of projections may comprise a n sets of concentric circles, wherein each set surrounds an aperture for receiving one or more fastening means or fasteners, e.g. wherein the aperture may be located in the centre of innermost circle of each set.

In embodiments, the array of projections (e.g. the array of upstanding walls) may comprise linear upstanding walls. The linear upstanding walls may extend from one aperture to another aperture. For example, the outer holding frame may comprise n apertures, for example arranged in a rectilinear pattern. The linear upstanding walls may extend from one aperture to an adjacent aperture, e.g. in a rectilinear pattern.

In embodiments, the array of projections (e.g. the array of upstanding walls) may comprise one or more set(s) of concentric circles in combination with one or more linear upstanding walls. The one or more linear upstanding walls may intersect the one or more set(s) of concentric circles.

In embodiments, the outer holding frame may comprise n apertures for receiving one or more fastening means or fasteners, and the array of projections may comprise n sets of concentric circles, wherein each set of concentric circles surrounds an aperture such that the aperture is located in the centre of the innermost concentric circle, the array of projections further comprising one or more linear upstanding walls intersecting the n sets of concentric circles, wherein each linear upstanding wall extends from one aperture to an adjacent aperture, in a rectilinear pattern.

The height of at least some, or all of, the upstanding walls may be between 1 mm to 8 mm, e.g. between 2 mm to 7 mm, or between 3 mm to 6 mm, or between 4 mm to 5 mm. In embodiments, the height of at least some, or all of, the upstanding walls may be from any one of 1, 2, 3, 4, 5, 6, 7, 8, 9 mm to any one of 10, 9, 8, 7, 6, 5, 4, 3, 2 mm.

The width of at least some, or all of, the upstanding walls may be between 0.1 to 4.0 mm, e.g. between 0.1 to 3.5 mm, or between 0.1 to 3 mm, or between 0.2 to 1.8 mm or between 0.4 to 1.7 mm, or between 0.6 to 1.6 mm, or between 0.8 to 1.5 mm. In embodiments, the width of at least some, or all of, the upstanding walls may be from any one of 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3 2.4, 2.5, 2.6, 2.7, 2.8, 2.9, 3.0, 3.1, 3.2, 3.3, 3.4, 3.5, 3.6, 3.7, 3.8, 3.9 mm to any one of 4.0, 3.9, 3.8, 3.7, 3.6, 3.5, 3.4, 3.3, 3.2, 3.1, 3.0, 2.9, 2.8, 2.7, 2.62=, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2 mm.

In embodiments the surface, e.g. the second major surface of the outer holding frame may be shaped to allow for an even compressive force across the whole battery assembly. For example, the space for accommodating cells between facing portions of facing holding frames may be different in different portions of the holding frame. For example the space (or gap size) may be defined between a holding frame and a second holding frame for accommodating cells may vary. The gap sizes closer to the apertures for receipt of fasteners may be larger than the gap sizes further from the apertures, to mitigate the increased effective clamping force experienced closer to the fasteners in use.

A further aspect of the invention provides a battery pack assembly, the assembly comprising a plurality of cells numbering in excess of four and each cell having terminals, an electrically conductive conductor plate for providing electrical contact to at least two of said plurality of cells, a first outer holding frame and a second outer holding frame, and reversible fasteners to apply a compressive force to secure the plurality of cells between the first outer holding frame and the second outer holding frame and to urge the terminals of the plurality of cells, the conductive conductor plate, and the outer holding frame into contact, wherein the plurality of cells are located in columns and rows and wherein the number of fasteners (B) is less than the number of cells (C×R) according to the following formula:

$$B \leq ( ( {C}_{C} - 1 ) . ( {C}_{R} - 1 ) ) - 1$$

and may meet the requirement:

$$1 \leq B \leq \frac{{C}_{C} . {C}_{R}}{4}$$

where C_{C} is the number of cells in each column and C_{R} is the number of cells in each row.

Advantageously, the fewer the fasteners the speedier the assembly and disassembly of a battery pack assembly. However, because the battery pack assembly requires compression to effect suitable contact between the cell terminals and the conductor plate reducing the number of fasteners will necessarily lead to an increase in the point load exerted by each fastener on the holding frame when seeking to maintain the required overall compressive force. The increased point load has to be borne by the holding frame. Of course, as the number of fasteners reduces there is a risk that an even compressive force will not be exerted across the entire set of cells, which could lead to a local loss of contact. We have found that these two requirements can be met by providing load-spreading structures on the external faces of the first outer holding frame and/or the second outer holding frame, to allow fewer fasteners to exert sufficient point load to achieve the overall compressive force necessary to achieve electrical contact whilst not having to significantly bolster the weight and/or thickness of the holding frames to accommodate the extra point load.

In an embodiment the number of fasteners B is lower than 12, for example 11, 10 or 9. Preferably the fasteners are located in an array, for example in columns and rows.

The battery pack assembly according to any aspect of the invention may comprise the following features.

One, some or each of the cells may have a terminal on one of the ends of the cells. One, some or each of the cells may have a terminal on either of the ends of the cells.

In embodiments, the conductor plate may be fabricated from a conductive plastics material or from one or more metal sheets. The conductor plate may be fabricated from aluminium, e.g. aluminium sheet. The conductor plate, such as the metal sheet, e.g. aluminium sheet, may be between 0.1 to 1.0 mm in thickness, e.g. from any one of 0.1, 0.2, 0.3, 0.4, 0.5, 0.6, 0.7, 0.8, 0.9 mm to any one of 1.0, 0.9, 0.8, 0.7, 0.6, 0.5, 0.4, 0.3, or 0.2 mm in thickness. Preferably, the metal sheet, e.g. aluminium sheet, is between 0.6 to 1.0 mm in thickness, e.g. between 0.7 to 0.9 mm thick, or 0.8 mm thick. Conductor plates are typically rigid, meaning that they are self-supporting.

The protrusions may be fabricated, for example, by stamping a metal sheet, which forms the conductor plate. Advantageously, the protrusions aid electrical contact to be made between the conductor plate, e.g. one or more conductive plates, and the cell terminals. One or more (e.g. each) of the protrusions will extend from the first major surface of the conductor plate. The second major surface may have a corresponding depression. This is advantageously achieved by stamping from a thin conductive material, e.g. a metal sheet. In embodiments, the protrusions extend from 0.1 to 3 mm from the plane of the conductor plate, e.g. from any one of 0.1, 0.2, 0.3, 0.4, 0.5, 0.6, 0.7, 0.8, 0.9, 1.0 mm to any one of 3, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1 mm from the plane of the conductive plate. The protrusions may extend from 0.5 to 2.0 mm from the plane of the conductive plate, say 0.6 to 1.9, 0.7 to 1.5, 0.8 to 1.4, 0.8 to 1.2 mm from the plane of the conductor plate.

The conductor plate preferably connects two or more cell terminals in parallel or series. Preferably, the arrangement of the conductor plate in the holding frame is complementary, such that the conductor plate and cells together form a complete circuit when the plurality of cells are held within the holding frame, electrically connecting all of the cells in the assembly in parallel and/or series. For example, the cells may be arranged with neighbouring cells alternatively positioned with the positive terminal upwards and the positive terminal downwards respectively, and the positive and negative terminals on each side being connected together, so that a complete circuit is formed.

The battery pack assembly may comprise more than one conductor plate. In embodiments, there may be provided two or more, e.g. three, four, five, or n conductor plates (where ‘n’ is a positive integer). In embodiments, one or more conductor plate(s) may be associated with a holding frame. In embodiments, a second one or more conductor plate(s) may be associated with a second holding frame. The conductor plates may be any shape which would cover more than one cell terminal, such as a sheet, or rectangular, U-shaped, S-shaped, L-shaped, T-shaped, H-shaped, and so on.

The one or more conductor plate(s) preferably connects two, three or more cell terminals in series. Preferably, the arrangement of the one or more conductor plate(s) in each of the two holding frames is complementary, such that they form a complete circuit when the plurality of cells are held within holding frame, or within two holding frames, electrically connecting all of the cells in the assembly in series. For example, the cells may be arranged with neighbouring cells alternatively positioned with the positive terminal upwards and the positive terminal downwards respectively, and the positive and negative terminals on each side being connected together, so that a complete circuit is formed.

In embodiments, the conductor plate may comprise ‘n’ protrusions for making contact with ‘n’ cell terminals.

The one or more or each conductor plate, may further comprise an electrical terminus to connect the appropriate conductor or conductor, e.g. conductor plate, to external means, e.g. an external circuit, to use the electrical power.

The holding frame may be fabricated from a polymeric material. The polymeric material may comprise one or more of Nylon (polyamide), polypropylene, polyurethane, acrylonitrile butadiene styrene. The polymeric material may comprise reinforcement. The polymeric material may comprise fibre reinforcement, for example, glass, ceramic, carbon fibres or strands. The conductive plate may be fabricated from aluminium sheet, which is stamped to form the protrusions, each of which extend by 0.8 to 1.2 mm from the plane of the conductor plate. It has been surprisingly found that a battery pack assembly according to the invention when assembled using fasteners tightened to a torque, of say between 0.5-10 Nm, preferably 0.5 to 2 Nm, e.g. 0.75 to 2 or 2 Nm, say 1 and 2 Nm, is able to maintain the contact between cells and conductor plates during use. This is particularly surprising for static or non-static uses, where the assembly may undergo significant vibration.

Additionally or alternatively, the battery pack assembly may further comprise one or more resilient member(s). In embodiments, the one or more resilient member(s) is located between the conductor plate and the holding frame to bear against the conductor plate to make electrical contact with one or more cell terminals in said closed condition.

In the battery pack assembly comprising one or more resilient member(s), the conductor is located between the resilient member and the cell terminals of said plurality of cells. The conductor comprises a first major surface for engaging the first, second, . . . n^{th} cell terminal, and a second major surface against which the resilient member bears. By the term ‘adjacent’, we mean that the respective contact on the first major surface of the conductor is in engagement with respective cell terminal and that the resilient member bears against the second major surface of the conductor in a corresponding position.

In embodiments, the battery pack assembly comprises a first resilient member located between a first conductor and a first holding frame, and a second resilient member located between a second conductor and a second holding frame.

The resilient member may bear against plural conductive plates of the conductor. In an embodiment the resilient member may bear against most or all of the conductive plates of the conductor.

In embodiments, the first contact of the conductor for engaging a first cell terminal and/or the second contact of the conductor for engaging a second cell terminal, is provided by a protrusion. The first contact may comprise a protrusion on a first major surface of the conductor. The first contact may comprise a rebate on a second major surface of the conductor. The rebate may correspond with the protrusion. There may be provided ‘n’ contacts for engagement with respective ‘n’ cell terminals. For example, a contact, e.g. a protrusion, may be provided on the conductor for engaging an n^{th} cell terminal. A contact, e.g. a protrusion, may be provided on the conductor to engage each cell terminal of the plurality of cells located within the battery pack assembly such that one contact, e.g. protrusion, is provided per cell terminal. The conductor will be oriented such that the protrusion will typically be directed towards the cell terminal.

In a closed condition of the battery pack assembly, the protrusions of the conductor extend towards the cell terminals. The portion of the resilient member adjacent the protrusion of the conductor is preferably urged to extend into the corresponding depression, where present, of the conductor, e.g. by fastening said fastening means or fastener. The resilience of the resilient member provides effective or intimate electrical contact between the conductor, for example a respective protrusion, and the cell terminals, when the battery pack assembly is in use.

The resilient member may be a unitary body. The resilient member may comprise a sheet. The resilient member may comprise one or more resilient sheets associated with a holding frame of the battery pack assembly. In embodiments, the resilient member may comprise two or more, e.g. three, four, five, resilient sheets. The resilient member may be seated within one or more of the holding frames. The resilient member may be sized to extend to one or more internal edges, and/or to the inner perimeter of a holding frame. Alternatively, the resilient member may be sized to have a smaller major surface than that of a holding frame.

In embodiments, the resilient member may comprise or consist of one or more sheets of resilient material, for example, a polymeric or elastomeric material. The resilient member may be fabricated from a rubber material. In an embodiment the resilient member may be fabricated from, or comprise, a silicone-based material, e.g. silicone rubber. In an embodiment the resilient material may be fabricated from ethylene-propylene-diene rubber, hydrogenated nitrile butadiene rubber or other rubbers. The resilient member may be formed from an expanded polymeric material, for example expanded polystyrene. The resilient member will have sufficient heat resistant properties to withstand typical battery operating temperatures.

Advantageously, the resilient member acts to encourage electrical contact between the first, second, or n^{th} contacts of the conductor for engagement with one or more cell terminals. For example, a portion of the resilient member may be forced into the depression corresponding to the protrusion of the conductor, when the assembly is under compression, e.g. from the fastening of the fastening means or fastener. This ensures intimate electrical contacts are maintained even when the assembly undergoes vibration.

In addition, the provision of a resilient member, for example a resilient member formed as a unitary body, e.g. that extends to one or more internal edges of the holding frame, provides enhanced and uniform electrical contact between the cell terminals and the conductor. The provision of a single resilient member ensures ease of manufacture. Moreover, a unitary body is easily manufactured and/or replaced if and when the component wears out to enable greater recyclability of the components of the assembly.

In embodiments wherein the first contact comprises a rebate or one or more rebates, for example where the first contact comprises a protrusion on a first major surface of the conductor and a corresponding rebate on a second major surface of the conductor, the resilient member may extend into one or more rebates, for example the one or more rebates on the second major surface of the conductor.

The resilient member may comprise or consist of a sheet comprising apertures. Each aperture may correspond to a respective locating member, e.g. a respective formation.

In embodiments, the battery pack assembly according to any aspect of the invention may comprise a housing, e.g. a housing comprising a base, the base comprising upstanding walls, and preferably further comprising a lid, for example a removable lid. The housing may hold the battery pack assembly. The housing may have terminals for connecting the cells to a site of use.

In embodiments, the battery pack assembly comprises one or more conduction breaking means or conduction breaker. A conduction breaking means or conduction breaker may be positioned between each cell terminal, and the conductor or conductor, which may be a conductor plate. Preferably, a conduction breaking means or conduction breaker is provided between every cell terminal and the associated conductor or conductor. The purpose of the one or more conduction breaking means of conduction breaker is to break the electrical circuit between a cell and the conductor or conductor, when said cell exceeds a prescribed electrical and/or thermal limit. Upon exceeding a prescribed electrical and/or thermal limit, the conduction breaking means of conduction breaker severs the connection of the failed cell, i.e. a cell that has exceeded a prescribed electrical and/or thermal limit, isolating said failed cell from the rest of the battery pack assembly.

The conduction breaking means or conduction breaker may comprise a first conductive portion for making contact with the cell terminal, a second conductive portion for making contact with the conductor or conductor, an insulating portion, and a conduction breaker portion. The conduction breaking means or conduction breaker may comprise a metallic alloy, or a multi-metallic element and may comprise a bimetal fuse. The conduction breaker portion may comprise a low melting material, for example, a metal such as silver, or silver-plated copper, tin, or zinc, or alloys of the same, which melts upon exceeding the electrical and/or thermal limit determined by the melting point of the material.

Advantageously, the contact between the conduction breaking means or conduction breaker with both the conductor one on major surface, and the cell terminal on the opposite major surface, is increased upon ‘tightening’ of the fastening means when the battery pack assembly is under compression. More advantageously, the one or more conduction breaking means or conduction breaker allow the battery pack assembly to continue to function upon failure of an individual cell, by isolating the one or more failed cells from the other functioning cells in the battery pack assembly.

In embodiments, the battery pack assembly comprises a monitoring means or monitor for monitoring the status of each cell. The monitoring means may comprise an integrated electrical circuit, which monitors the status of each cell by detecting the number of triggered conduction breaking means or conduction breakers resulting from failed cells, i.e. a cell that has exceeded a prescribed electrical and/or thermal limit, within the battery pack assembly. The monitoring means may comprise a method of determining the condition of the battery pack assembly. For example, the monitoring means may transmit data, which has been collected about the status of each cell within the assembly, to be fed through an algorithm to compare with the optimal function of the assembly, to determine the number of fully functioning cells and the number of failed cells. Advantageously, this provides information on the overall condition and remaining useful life of the battery pack assembly. More advantageously, this information may be used to inform the user of maintenance requirements, and of potential safety hazards from using an under-performing battery pack assembly.

The battery pack assembly may be any format including laminates, pouch, cylindrical, and/or prismatic.

The design of the assembly also allows for the integration of liquid cooling for high power applications.

In an embodiment the battery pack assembly has a mass of 12 kg or more and/or a power storage of 1 kWh or more. In an embodiment the battery pack assembly is a large format battery pack.

The battery pack assembly of the invention may be readily demountable and/or separable into its constituent parts, thereby allowing for the replacement or maintenance of one or more of the cells within the battery pack assembly.

A further aspect of the invention provides a method for assembling a battery pack assembly, the method comprising:
providing a holding frame having a first major surface and a second major surface, one or both major surfaces comprising plural cell-locating structures shaped and/or sized and/or configured to seat plural cells, the plural cell-locating structures each comprising a first wall upstanding from one of the first or second major surfaces, the upstanding first wall comprising a free or terminal portion which is shaped to provide a lead-in portion; locating a conductor plate on the holding frame;
locating a plurality of cells on the conductor plate by moving the cells past the lead-in portion of each cell-locating structure.

The method may further comprise providing a second frame having a first major surface and a second major surface, one or both major surfaces comprising plural cell-locating structures shaped and/or sized and/or configured to seat plural cells, the plural cell-locating structures each comprising a first wall upstanding from one of the first or second major surfaces, the upstanding first wall comprising a free or terminal portion which is shaped to provide a lead-in portion.

The method may comprise locating the second frame over said plurality of cells by moving the lead-in portion past the free end of the cells such that a first major surface is adjacent or proximate the cells.

A conductor plate may be provided between the second frame and the cells.

The second frame may be an end frame or an intermediate frame.

Where the second frame is an intermediate frame, the method may comprise locating a second plurality of cells on the intermediate holding frame.

The intermediate frame may comprise a second major surface comprising plural cell-locating structures shaped and/or sized and/or configured to seat plural cells, the plural cell-locating structures each comprising a first wall upstanding from one of the first or second major surfaces, the upstanding first wall comprising a free or terminal portion which is shaped to provide a lead-in portion.

The method may comprise providing further intermediate holding frames and further arrays of cells.

In embodiments, the method may comprise providing an outer holding frame, the outer holding frame having a first major surface and a second major surface, one or both major surfaces comprising plural cell-locating structures shaped and/or sized and/or configured to seat plural cells, the plural cell-locating structures each comprising a first wall upstanding from one of the first or second major surfaces, the upstanding first wall comprising a free or terminal portion which is shaped to provide a lead-in portion.

In embodiments, the method may further comprise providing an n^{th} holding frame, the n^{th} holding frame having a first major surface and a second major surface, one or both major surfaces comprising plural cell-locating structures shaped and/or sized and/or configured to seat plural cells, the plural cell-locating structures each comprising a first wall upstanding from one of the first or second major surfaces, the upstanding first wall comprising a free or terminal portion which is shaped to provide a lead-in portion.

The method may comprise locating a conductor plate between the n^{th} holding frame and an n^{th} set of cells. The method may comprise locating the second set of cells between a or the holding frame and the n^{th} holding frame.

In embodiments, the method may comprise providing one or more resilient member(s) between the conductor plate, e.g. one or both of a first conductor plate or a second conductor plate, and the holding frame, e.g. one or both of a first holding frame and a second holding frame.

In embodiments, the method may comprise providing fastening means for reversibly holding the holding frame and the plurality of cells, e.g. a first and second holding frame with respect to one another, in a closed condition.

In embodiments, the fastening means may cause the holding frame to bear directly against the conductor plate to cause the protrusions of the conductor plate to make electrical contact with the cell terminals.

A yet further aspect of the invention provides a method for disassembling a battery pack assembly according to the invention, the method comprising optionally removing the fastening means, removing the holding frame from the battery pack assembly, removing the conductor plate, and removing at least one of the plurality of cells from the battery pack assembly.

Advantageously, disassembling the battery pack according to the invention allows for ease of maintenance and re-use of some or all of the components in further battery packs.

Moreover, the battery pack components may be re-used multiple times with new and once used cells.

The battery pack assembly of the invention may be used as a power source for consumer goods, vehicles, for example, electric vehicles or as a renewable energy store (for example when linked to a renewable energy source such as solar, wind or tide power generator).

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

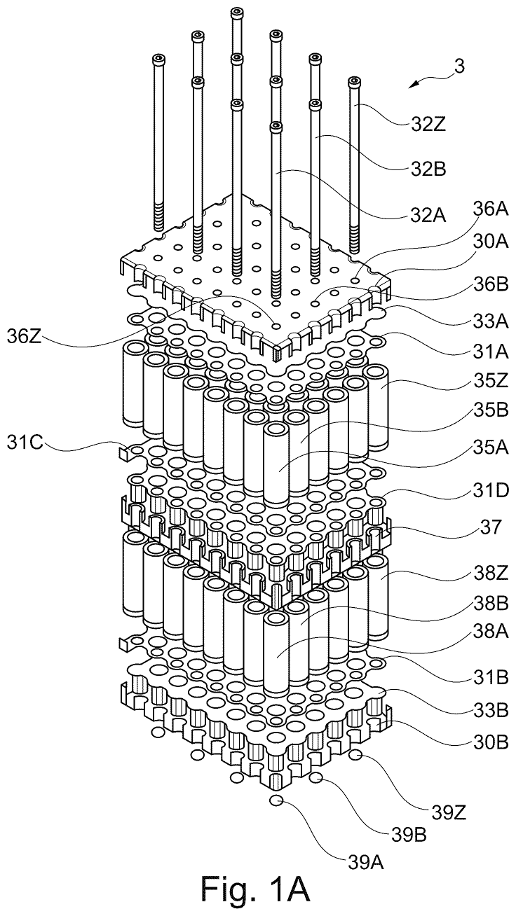

FIG. 1A to 1C are exploded views of a battery pack assembly according to the prior art;

FIG. 1D is a plan view of the battery pack assembly of FIGS. 1A to 1C according to the prior art;

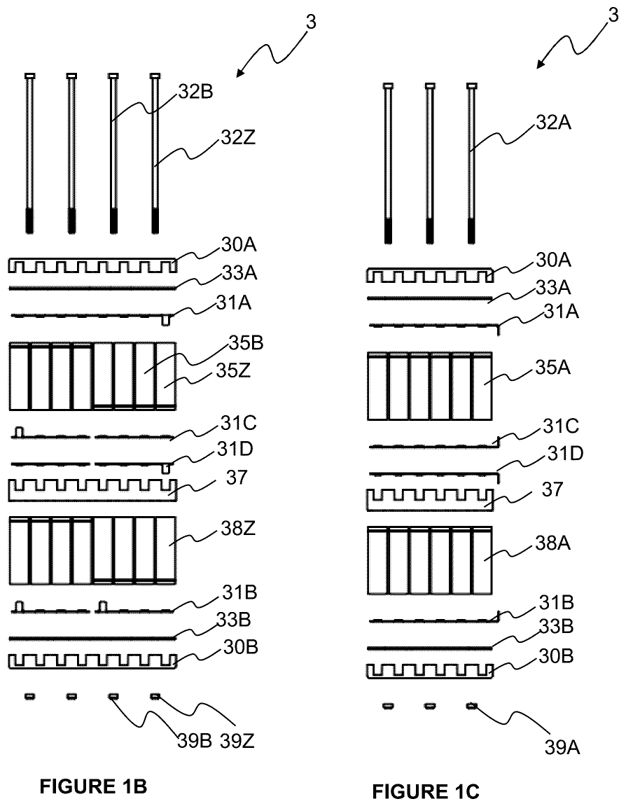

FIG. 2 is a battery pack assembly according to a first embodiment of the invention;

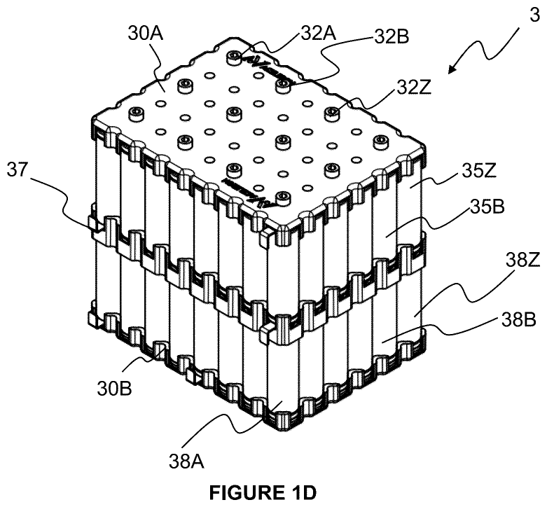

FIG. 3 is an intermediate holding frame shown in FIG. 2 in more detail;

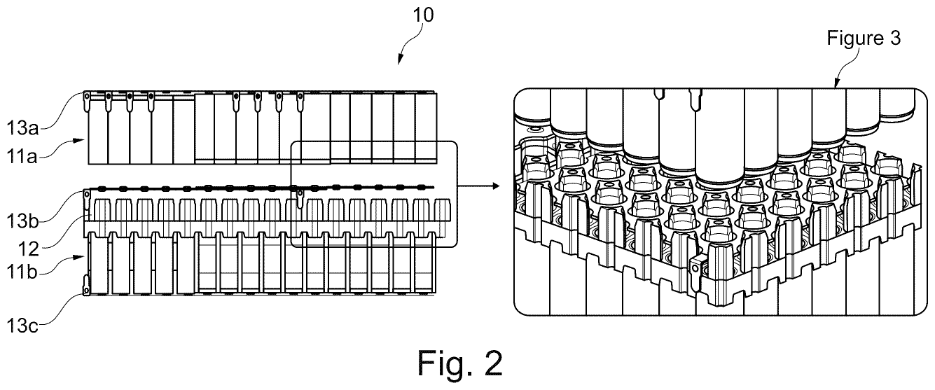

FIG. 4 is a schematic illustration of a cell-locating structure on the holding frame of FIG. 3;

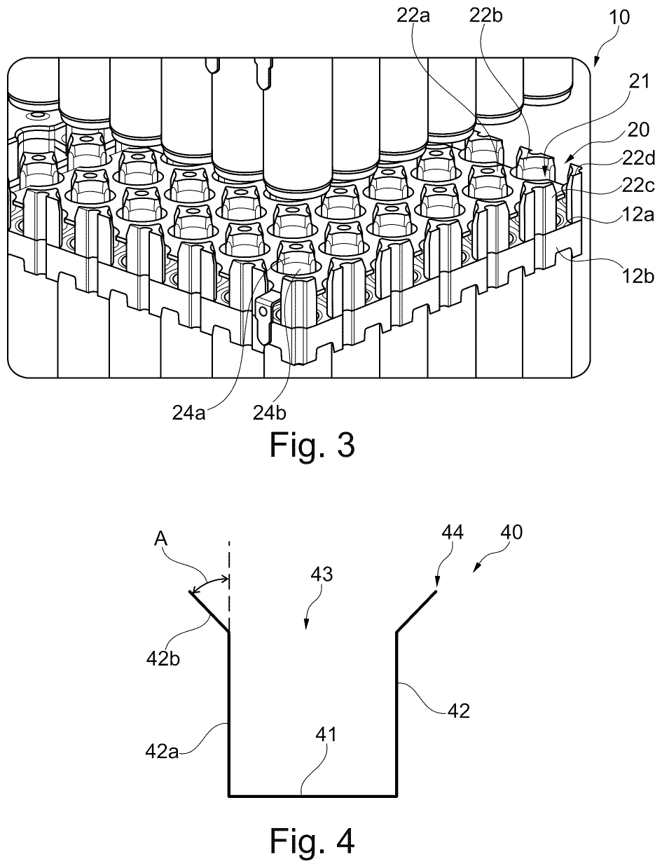

FIG. 5 shows battery pack assemblies according to further embodiments of the invention;

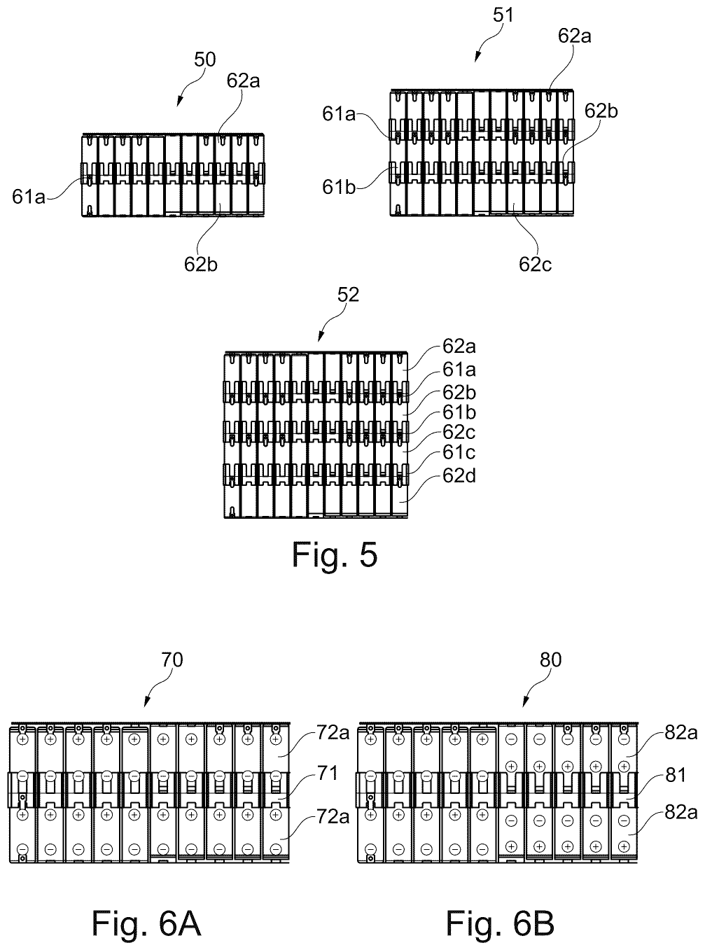

FIGS. 6a and 6b show battery pack assemblies according to yet further embodiments of the invention;

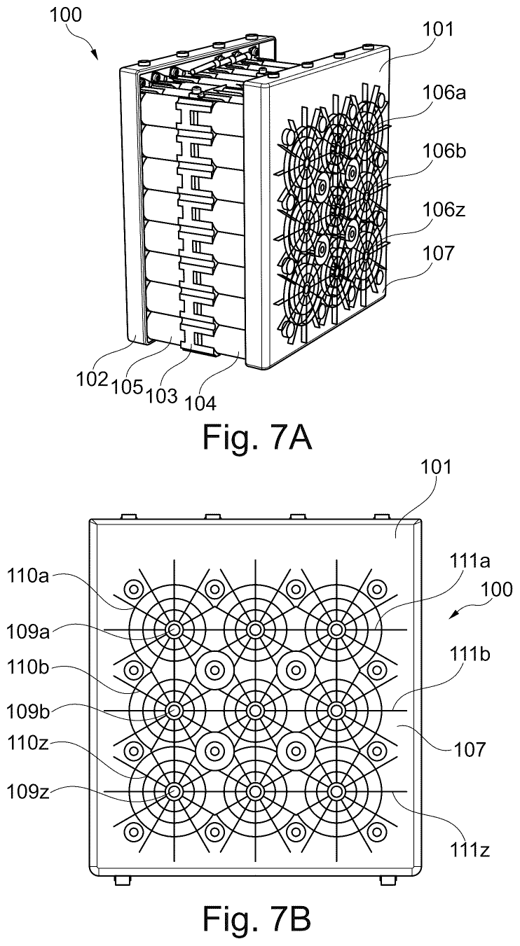

FIGS. 7a and 7b shows a battery pack assembly according to a further embodiment of the invention;

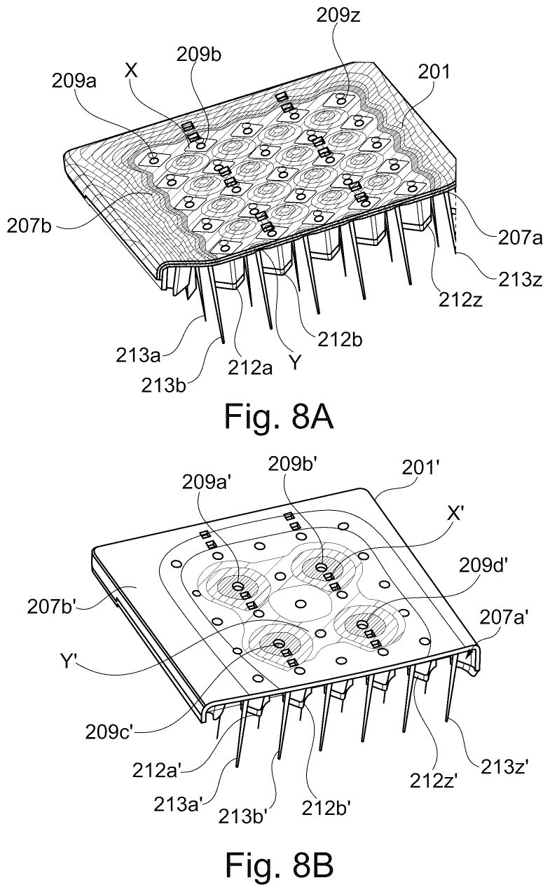

FIGS. 8A and 8B show holding frames according to further embodiments of the invention; and

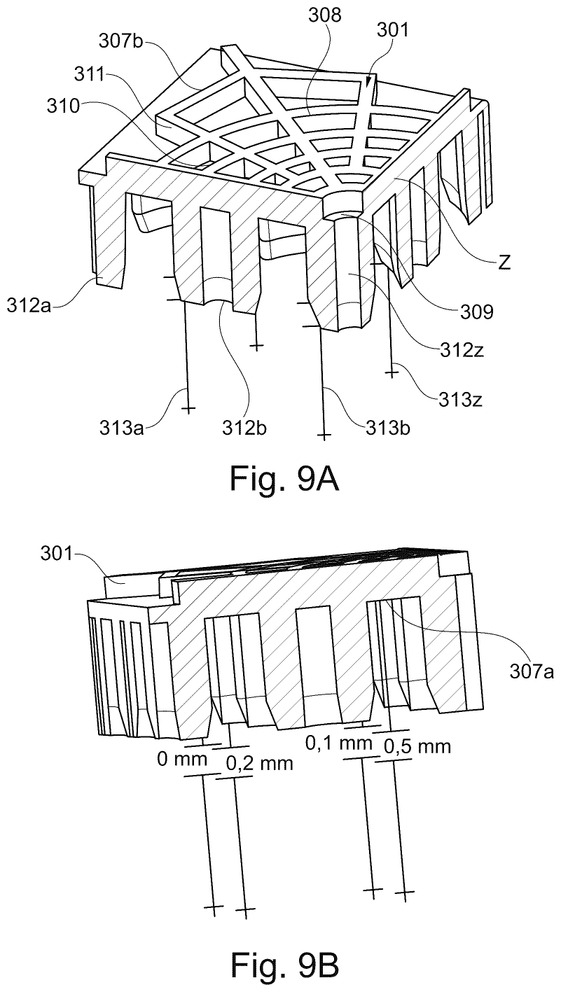

FIGS. 9A and 9B show a repeating unit of a holding frame according to a yet further embodiment of the invention.

Referring first to FIGS. 1A to 1C, there is shown exploded views of a battery pack assembly 3 disclosed in our earlier patent application WO2020128533. Referring also to FIG. 1D, there is shown the battery pack assembly 3 in an assembled or closed condition.

The battery pack assembly 3 comprises a first outer holding frame 30A, a second outer holding frame 30B, an intermediate holding frame 37, a first conductor 31A, a second conductor 31B, a third conductor 31C, a fourth conductor 31D, a plurality of fasteners 32A, 32B, . . . 32Z, a first resilient member 33A, and a second resilient member 33B.

The battery pack assembly 3 is configured in use to hold a first plurality of cells 35A, 35B, . . . 35Z between the first outer holding frame 30A and the intermediate holding frame 37 in a longitudinal configuration. The battery pack assembly 3 is further configured in use to hold a second plurality of cells 38A, 38B, . . . 38Z between the intermediate holding frame 37 and the second outer holding frame 30B in a longitudinal configuration.

The third conductor 31C is located between the first plurality of cells 35A, 35B, . . . 35Z and the fourth conductor 31D. The fourth conductor 31D is located between the third conductor 31C and the intermediate holding frame 37. The intermediate holding frame 37 is located between the fourth conductor 31D and the second plurality of cells 38A, 38B, . . . 38Z.

In this embodiment, the battery pack assembly 3 is configured to hold forty-eight cells in the first plurality of cells 35A, 35B, . . . 35Z, and forty-eight cells in the second plurality of cells 38A, 38B, . . . 38Z. The cells may, for example, lithium ion batteries. For convenience only three cells are labelled for each set in FIG. 1A.

The first outer holding frame 30A further comprises slots 36A, 36B, . . . 36Z for receiving the fasteners 32A, 32B, . . . 32Z.

The second outer holding frame 30B and the intermediate holding frame 37 also comprise slots (not shown) for receiving the fasteners 32A, 32B, . . . 32Z such that each fastener, for example 32A, is inserted into the slot 36A of the first holding frame 30A and is received within a corresponding slot (not shown) in the intermediate holding frame 37 and the second outer holding frame 30B. The fasteners 32A, 32B, . . . 32Z are bolts, twelve bolts being provided. The slots 36A, 36B, . . . 36Z are configured to receive the fasteners 32A, 32B, . . . 32Z and as such there are twelve slots provided. The fasteners 32A, 32B, . . . 32Z are secured in place by nuts 39A, 39B, . . . 39Z.

In use, the fasteners 32A, 32B, . . . 32Z are received in the slots 36A, 36B, . . . 36Z, and are configured using compressive forces to reversibly hold the first outer holding frame 30A, the intermediate holding frame 37, and the second outer holding frame 30B with respect to one another in a closed or assembled condition.

In the closed or assembled condition, the fasteners 32A, 32B, . . . 32Z cause terminals of the first plurality of cells 35A, 35B, . . . 35Z and the second plurality of cells 38A, 38B, . . . 38Z to be urged against the first conductor 31A and the second conductor 31B respectively.

The first conductor 31A is positioned between the first resilient member 33A and the terminals of each of the cells in the first set 35A, 35B, . . . 35Z. In a like manner, the second conductor 31B is positioned between the second resilient member 33B and the terminals of each of the cells in the second set 38A, 38B, . . . 38Z.

The conductive plates 31A, 31B, 31C comprise plural protrusions. There is provided one protrusion per cell terminal such that the conductive plates are in electrical contact with each cell terminal via a protrusion.

In an assembled configuration, the holding frame 30A is positioned adjacent the resilient member 33A, and the conductive plate 31A is positioned between the resilient member 33A and the terminal of the first set of cells 35A, 35B, . . . 35Z.

Similarly, in an assembled configuration, the holding frame 30B is positioned adjacent the resilient member 33B, and the conductive plate 31B is positioned between the resilient member 33B and the terminal of the second set of cells 38A, 38B, . . . 38Z.

The first and second conductor 31A, 31B, and the first and second resilient members 33A, 133B each comprise apertures. The apertures are located in areas that are not in contact with the cell terminals when the battery pack assembly 3 is assembled and correspond and cooperate with the cell-locating structures.

The first resilient member 33A functions to urge the first conductor 31A into contact with the terminals at the first end of each of the plurality of cells 35A, 35B, . . . 35Z. In a like manner, the second resilient member 33B functions to urge the first conductor 31B into contact with the terminals at the second end of each of the plurality of cells 35A, 35B, . . . 35Z.

The resilient members are fabricated as a unitary body from silicone rubber, which is particularly effective material for use in performing the aforementioned function by extending into depressions corresponding to each of the plural protrusions provided on the first and second conductor plates 31A, 31B, 31C, 31D when a compressive force is applied to the battery pack assembly 3.

The fasteners 32A, 32B, . . . 32Z are reversible, and as such, removal or loosening of the fasteners 32A, 32B, . . . 32Z enables the plurality of cells to be freed from the battery pack assembly 3, when in an opened or disassembled condition.

The resilient members need not be present, for example, as shown in our earlier patent application WO2020128532.

Referring now to FIG. 2, there is shown a battery pack assembly 10 according to the first embodiment of the invention. The battery pack assembly 10 shares many of the features of the battery pack assembly 3 of the prior art of FIG. 1A.

The battery pack assembly 10 comprises a first set of cells 11a, a second set of cells 11b, an intermediate holding frame 12, a first conductor plate 13a, a second conductor plate 13b, and a third conductor plate 13c.

The first set of cells 11a is located between the first conductor plate 13a, and the second conductor plate 13b. The intermediate holding frame 12 is located between the second conductor plate 13b and the second set of cells 11b. The second set of cells 11b is located between the intermediate holding frame 12 and the third conductor plate 13c.

The intermediate holding frame 12 is shown in more detail in FIG. 3. The intermediate holding frame 12 comprises a first major surface 12a and a second major surface 12b. The intermediate holding frame 12 comprises plural cell-locating structures, e.g. 20. In this embodiment, the cell-locating structures, e.g. 20, are shaped and/or sized and/or configured to seat one or more cylindrical cells. The cell-locating structures, e.g. 20, comprise an opening 21 and a base (not shown). In this embodiment, the cell-locating structure, e.g. 20, comprises four upstanding walls 22a, 22b, 22c, and 22d. The four upstanding walls 22a, 22b, 22c, and 22d of the upstanding wall form a broken peripheral edge at the opening 21 of the cell-locating structure 20. The perimeter (e.g. the second diametric dimension) of the peripheral edge is larger than the smallest internal perimeter (e.g. the first diametric dimension) of the upstanding wall.

In this embodiment, the intermediate holding frame 12 comprises cell-locating structures on both major surfaces. Advantageously, the intermediate holding frame 12 may be used to stack two or more sets of cells 11a, 11b in a battery pack assembly 10 by locating one set of cells 11a in the one or more cell-locating structures on the first major surface 12a, and locating a second set of cells 11b in the one or more cell-locating structures on the second major surface 12b.

In this embodiment, there are forty eight (8×6) cells in each set of cells 11a, 11b.

The intermediate holding plate 12 comprises an array of upstanding walls, e.g. 22a, 22b, 22c, 22d which cooperate to provide forty eight (8×6) cell-locating structures. The cell-locating structures, e.g. 20, provide regions of the intermediate holding frame 12 in which cells are located or locatable.

Each upstanding wall, e.g. 22a, 22b, 22c, and 22d, comprises a tapered portion, e.g. 24a, and a non-tapered portion 24b. The tapered portion 24a extends from the peripheral edge to the smallest internal perimeter (e.g. the first diametric dimension) of the upstanding wall. The non-tapered portion comprises the smallest internal perimeter (e.g. the first diametric dimension) of the upstanding wall.

The conductor plate 13b comprises protrusions for contacting the terminals of the first set of cells 11a similar to those described in our patent application WO2020128532. Advantageously, the alignment of the conductor plate 13b is facilitated by the intermediate holding frame 12.

Referring now to FIG. 4, there is shown a schematic illustration of a upstanding wall 40. The upstanding wall 40 comprises a base 41, an upstanding wall 42, and an opening 43. The upstanding wall 42 comprises a peripheral edge 44 at the opening 43 having a perimeter (e.g. a second diametric dimension). The upstanding wall 42 also comprises a smallest internal perimeter 45 (e.g. the first diametric dimension). The perimeter of the peripheral edge 44 (e.g. a second diametric dimension) is larger than the smallest internal perimeter 45 (e.g. the first diametric dimension) of the upstanding wall.

The upstanding wall 42 comprises a tapered portion 42a and a non-tapered portion 42b. The angle A formed by the tapered portion is between 20 to 45 degrees. Advantageously, the lead-in angle A enables a battery pack assembly to be rapidly and efficiently assembled without having to perfectly align the axis of each cell with the axis of the upstanding wall 42 of the cell-locating structure 40 to seat each cell within the cell-locating structure 40. This is because the perimeter of the peripheral edge 44 (e.g. the second diametric dimension) is larger than the smallest internal perimeter 45 (e.g. the first diametric dimension) of the upstanding wall, which provides a lead-in for the cell to be positioned within the cell-locating structure 40. This reduces assembly times of the battery pack assembly by facilitating alignment of the cells within the cell-locating structures.

Referring now to FIG. 5, there is shown battery pack assemblies 50, 51, 52 comprising different numbers of sets of cells and holding plates. Battery pack assembly 50 comprises one holding plate 61a and two sets of cells 62a, 62b. Battery pack assembly 51 comprises two holding plates 61a, 61b, and three sets of cells 62a, 62b, 62c. Battery pack assembly 52 comprises three holding plates 61a, 61b, 61c, and four sets of cells 62a, 62b, 62c, 62d. Advantageously, the holding plate according to the invention may be used to assemble battery pack assemblies comprising more than one set of cells.

As will be appreciated, current is collected from batteries within a set by the conductor plates associated with the holding frames and adjacent sets of cells are connected in series to provide an electrical output of the battery assembly.

Referring now to FIG. 6a, there is shown a battery pack assembly 70 comprising one holding plate 71 according to the invention and two sets of cells 72a, 72b. The cells are arranged in parallel with the same electrode orientation.

Referring now to FIG. 6b, there is shown a battery pack assembly 80 comprising one holding plate 81 according to the invention and two sets of cells 82a, 82b. The cells are arranged in series with different electrode orientations.

Referring now to FIG. 7a, there is shown a battery pack assembly 100 according to a further embodiment of the invention. The battery pack assembly 100 comprises a first and second outer holding frame 101, 102, an intermediate holding frame 103. A first plurality of cells 104 (64 cells 104 as shown in the drawings) is located in between the first outer holding frame 101 and the intermediate holding frame 103. A second plurality of cells 105 (64 cells 105 as shown in the drawings) is located between the second outer holding frame 102 and the intermediate holding frame 103.

Each outer holding frame 101, 102 has a first major surface (not shown) and a second major surface 107, the first major surface of having one or more cell-locating structures (not shown) which are shaped and/or sized and/or configured to accommodate at least a portion of one or more cells,

The battery pack assembly 100 further comprises electrically conductive conductor plate (not shown) located between the first holding frame 101 and at least some of the terminals of the first plurality of cells 104, and also between the second holding frame 102 and at least some of the terminals of the second plurality of cells 105. At least one of the holding frames 101, 102, 103 may comprise lead in portions or other features as described in relation to FIGS. 2 to 6 above.

The battery pack assembly 100 further comprises reversible fastening means 106a, 106b, . . . 106z configured to apply a compressive force to urge the terminals of the plurality of cells 104, 105 into contact with the electrically conductive conductor plate (not shown). In this embodiment, the battery pack assembly 100 comprises nine reversible fasteners.

Referring also to FIG. 7b, there is shown the first outer holding frame 101 of the battery pack assembly 100 in more detail.

It is shown that the second major surface 107 of the first outer holding frame 101 comprises an array of projections 108 configured to distribute the compressive force applied by the fasteners 106a, 106b, . . . 106z across the second major surface 107 of the first outer holding frame 101. Although it is not shown, in this embodiment the second outer holding frame 102 is identical to the first outer holding frame 101, although this need not be the case in other embodiments.

In this embodiment, the first outer holding frame 101 further comprises nine apertures 109a, 109b, . . . 109z for receiving nine fasteners 106a, 106b, . . . 106z.

The array of projections 108 comprises nine sets of concentric circles 110a, 110b, . . . 110z, wherein each set of concentric circles 110a, 110b, . . . 110z surrounds an aperture 109a, 109b, . . . 109z such that the aperture 109a, 109b, . . . 109z is located in the centre of the innermost concentric circle. The array of projections 108 further comprises plural linear upstanding walls 111a, 111b, . . . 111z intersecting the n sets of concentric circles 110a, 110b, . . . 110z, wherein each linear upstanding wall 111a, 111b, . . . 111z extends from one aperture 109a, 109b, . . . 109z to an adjacent aperture 109a, 109b, . . . 109z, in a rectilinear pattern.

The battery pack assembly 100 is configured such that the compressive force applied by the fastening means 106a, 106b, . . . 106z is distributed across the surface of the first outer holding frame 101. Advantageously, this reduces the number of required compression points, and therefore the number of fasteners 106a, 106b, . . . 106z, e.g. nuts and bolts, required to urge the terminals of the plurality of cells 104, 105, the conductive conductor plate, and the first outer holding frame 101 into contact. Advantageously, a battery pack assembly 100 comprising fewer fasteners 106a, 106b, . . . 106z is more efficiently assembled and disassembled.

It has been surprisingly found that the battery packs of the invention can be effectively formed with very few components, for example a battery pack comprising 128 cells can be formed using as few as 9 compression bolts, as shown in FIG. 7A, 7B, which is significantly fewer than the number of cells shown in the drawings.

### EXAMPLES

We conducted finite element analysis (FEA) to understand the levels of stress and deformation arising within the battery pack assembly.

### Example 1

Referring to FIG. 8A, there is shown half of a first outer holding frame 201 of a battery pack assembly according to a further embodiment of the invention. The first outer holding frame 201 has a first major surface 207a and a second major surface 207b. The first major surface 207a has cell-locating structures 212a 212b, . . . 212z which are shaped and/or sized and/or configured to accommodate at least a portion of one or more cells, wherein lines 213a, 213b, . . . 213z represent the idealised location of the cells. In this embodiment in each half of the first outer holding frame there are 25 cell-locating structures 213 arranged in a 5×5 grid and space for 36 cells arranged in a 6×6 grid.

The first outer holding frame 201 further comprises apertures 209a, 209b, . . . 209z for receiving fasteners. In use, the fasteners are configured to apply a compressive force to urge the terminals of the plurality of cells into contact with an electrically conductive conductor plate. In this embodiment, each half of the first outer holding frame 201 comprises 25 apertures 209 arranged in a 5×5 grid.

Although it is not shown, a battery assembly may be formed comprising a second outer holding frame which is identical to the first outer holding frame 201, although this need not be the case.

FEA analysis of a battery pack assembly comprising the first outer holding frame 201 formed of a polypropylene isotropic linear elastic model E=1950 MPa at 23° C. was conducted. A torque of 0.75 Nm resulted in a clamping force of 600 N per fastener, with a total clamping force of 15000 N/2 per holding frame.

As expected, higher levels of stress and greater deformation of the holding plate 201′ were calculated in areas which were closer to the fasteners, with the central cells having to withstand the force of 4 fasteners. The principal stress at point X was calculated as 338.0 MPa whereas, the principal stress at point Y was 114.2 MPa (see FIG. 8A).

### Example 2

Referring now to FIG. 8B, there is shown a first outer holding frame 201′ according to a further embodiment of the invention. The first outer holding frame 201′ of FIG. 8B is similar to the first outer holding frame 201 of FIG. 8A. Like features are depicted with like reference numerals followed by prime (′) and will therefore not be described further herein.

The first outer holding frame 201′ differs from the first outer holding frame 201 in that only four apertures 209a-d′ (for receiving fasteners) are present.

FEA analysis of a battery pack assembly comprising the outer holding frame 201′ formed of a polypropylene isotropic linear elastic model E=13000 MPa at 23° C. was conducted.

A clamping force of 2500 N per fastener resulted in a total clamping force of 10000 N/2 per holding frame.

The principal stress at point X′ was calculated as 1078.4 MPa whereas, the principal stress at point Y was 80.3 MPa (FIG. 8B).

From the FEA analysis of the first outer holding frames 201, 201′ of Examples 1 and 2, it is evident that with a reduced number of fasteners present the level of stress and thus deformation of the holding frame is reduced in areas located further from the fastener (e.g. at point Y, Y′) but that the level of stress and deformation at the site of the fastener is greater (X, X′).

Advantageously, a battery pack assembly comprising fewer fasteners is more efficiently assembled and disassembled and is lighter in weight.

However, a battery pack assembly comprising a greater number of fasteners allows for a greater compressive force and thus improved connection.

### Example 3

Referring now to FIGS. 9A and 9B, there is shown a repeating unit 301 of a first outer holding frame according to a further embodiment of the invention. The repeat unit 301 of the first outer holding frame has a first major surface 307a and a second major surface 307b. The first major surface 307a has cell-locating structures 312a, 312b, . . . 312z which are shaped and/or sized and/or configured to accommodate at least a portion of one or more cells, wherein lines 313a, 313b, . . . 313z represent the idealised location of the cells. In this embodiment each repeat unit 301 comprises 1/16 of the first outer holding frame to accommodate a 2×2 array of cells (i.e. 64 cells per holding frame).

The repeat unit 301 of the first outer holding frame further comprises apertures 309 for receiving fasteners. In use, the fasteners are configured to apply a compressive force to urge the terminals of the plurality of cells into contact with an electrically conductive conductor plate. In this embodiment, the repeat unit 301 of the first outer holding frame comprises apertures such that the entire holding frame accommodates 9 fasteners in a 3× array (for example see FIG. 7b).

Although it is not shown, a battery assembly may be formed comprising a second outer holding frame comprises repeating units which are identical to the repeating units 301 of the first outer holding frame, although this need not be the case in other embodiments.

The array of projections 308 comprise a quadrant of concentric circles 310, wherein four repeating units 301 of the first outer holding frame together form a set of complete concentric circles 310. Each set of concentric circles 310 surrounds an aperture 309 such that the aperture 309 is located in the centre of the innermost concentric circle. The array of projections 308 further comprises plural linear upstanding walls 311 intersecting the sets of concentric circles 310, wherein the or each linear upstanding wall 311 extends from one aperture 309 to an adjacent aperture 309, in a rectilinear pattern.

In this embodiment, the height of each array of projections 308 is 4 mm and the thickness 3 mm, although we have found that heights of 2 to 8 mm and thicknesses of 1 to 6 mm can be used.

In use, the battery pack assembly is configured such that the compressive force applied by a fastening means is distributed across the surface of the repeating units 301 of the first outer holding frame. Advantageously, this reduces the number of required compression points, and therefore the number of fasteners e.g. nuts and bolts, required to urge the terminals of the plurality of cells, the conductive conductor plate, and the first outer holding frame 301 into contact. Advantageously, a battery pack assembly comprising fewer fasteners is more efficiently assembled and disassembled.

Provision of the array of projections 308 has been shown to overcome the increased deformation around the fastener which arises as a result of the reduced number of fasteners. The principal stress of the repeating unit 301 of the first outer holding frame, at point Z (FIG. 9A) is 311.4 MPa as opposed to the principal stress of the first outer holding frame 201′ of Example 2, which comprises 4 fasteners per 36 cells, which is 1078.4 MPa at point X′ (FIG. 8B). The principal stress observed with Example 3 is more in line with that observed for the first outer holding frame 201 of Example 1, which comprises 25 fasteners per 36 cells, which is 338.0 MPa at point X (FIG. 8A).

As will be appreciated, there needs to be balance between compressive force applied and the weight of the battery assembly. Whilst more fasteners will ensure securement, it will also add weight. Also, for battery assemblies which are held together by compression, the more fasteners the longer the time required to assemble and disassemble. Our studies show that effective compression over the lifetime of the battery assembly can be achieved by 9 fasteners for an 8×8 array of cells, even when used in a FCFCF architecture.

Clearly, the effect of the compression exerted by the fasteners might be mitigated by increasing the size or thickness of the holding frame or changing materials. However, it is advantageous to use cheap and readily available materials. It is also advantageous to use materials which are readily formable, for example by injection moulding. Increasing the thickness of the holding frame adds weight and volume to the overall assembly. Accordingly, in order to spread the load from the fastener to (at least partially) mitigate or obviate bending of the frame, it has been found that the provision of the projections 308 with a wall thickness and height as explained above helps to spread the load with minimal increase in weight.

Referring to FIG. 9B, in order to achieve an even compressive force across the whole battery assembly, different gap sizes are defined between the repeating unit 301 of the outer holding frame and the electrically conductive conductor plate which forms part of the battery assembly. The gap sizes closer to the apertures 309 are larger than the gap sizes further from the apertures 309. Accordingly, closer to the aperture for the fastener where the clamping force would be greatest, the larger distance means that the greater clamping force is mitigated, whereas further from the aperture for the fastener, where clamping forces would be expected to fall off the closer spacing between the holding frames mitigates the fall-off. As will be appreciated, such subtle changes in spacing may be accommodated by moulding, for example by suitably forming the mould tool which is used to fabricate the holding frame. As shown, the variation may be from 0.5 mm to 0.2 mm to allow for even compression.

The variation may be altered from different cell types. For example smaller cells (e.g. 18650 cells) may require different gap sizes to larger cells (e.g. 21700 or 26650 cells). Larger cells tend to have a larger terminal and may be subject to buckling if exposed to too high a compressive force. Gap sizes are chosen depending on the size of the cell and the architecture of the battery pack assembly. However, in all cases, a difference of less than 1 mm has been found appropriate to ensure compression over the lifetime of the battery assembly.

Accordingly, the cells which are closest to the fasteners will be located between holding frames with a first gap size, those which are further away from the fasteners will fit between holding frames which may have a different gap size and those even further away will fit between holding frames which may have a yet further different gap size, the gap size preferably decreasing as a function of distance from the fastener. Of course, with plural fasteners the combined effect of compression will be assessed for each cell locating structure to ensure that compression is substantially even.

It will be appreciated by those skilled in the art that several variations to the aforementioned embodiments are envisaged without departing from the scope of the invention.

It will also be appreciated by those skilled in the art that any number of combinations of the aforementioned features and/or those shown in the appended drawings provide clear advantages over the prior art and are therefore within the scope of the invention described herein.

1-35. (canceled)

36. A holding frame for use in manufacturing a battery pack assembly, the holding frame having a first major surface and a second major surface, on one or both of the first major surface and the second major surface the holding frame has one or more cell-locating structures which are shaped and/or sized and/or configured to accommodate at least a portion of one or more cells, the one or more cell-locating structures comprising a first wall upstanding from one of the first or second major surfaces, the first upstanding wall comprising a first portion extending from the first or second major surface and a free or terminal portion which is shaped to provide a lead-in portion terminating at a distal end, the free or terminal portion providing a minor portion of the upstanding wall and the holding frame extending from the first major surface to the distal end.

37. A holding frame according to claim 36, wherein at least one cell-locating structure comprises a second upstanding wall.

38. A holding frame according to claim 37, wherein the second upstanding wall comprises a terminal edge shaped to provide a lead-in portion.

39. A holding frame according to claim 36, comprising an array of plural cell-locating structures, each of said plural cell-locating structures defining a cell-locating zone for a cell.

40. A holding frame according to claim 39, wherein each of said plural cell-locating structures comprises plural upstanding walls to provide a discontinuous boundary about each cell-locating zone.

41. A holding frame according claim 36, wherein the frame has a periphery comprising a peripheral wall extending from one or both of the first major surface and the second major surface, wherein the at least one cell-locating structure is located inboard of the periphery.

42. A holding frame according to claim 36, wherein the one or more cell-locating structures are provided on the first major surface.

43. A holding frame according to claim 42, wherein the second major surface comprises an array of projections.

44. A holding frame according to claim 43, wherein the array of projections on the second major surface comprises one or more sets of concentric circles.

45. A holding frame according to claim 44, comprising an aperture for the receipt of a fastener, located at the centre of the or each of said one or more sets of concentric circles.

46. A holding frame according to claim 43, wherein the array of projections comprise linear upstanding walls.

47. A holding frame according to claim 45, wherein linear walls extend between adjacent apertures for receipt of fasteners.

48. A holding frame according to claim 36, wherein further cell-locating structures are provided on the second major surface.

49. A holding frame according to claim 48, wherein the further cell locating structures comprise a first upstanding wall having a first portion extending from the second major surface and a free or terminal portion which is shaped to provide a lead-in portion terminating at a distal end, the free or terminal portion providing a minor portion of the upstanding wall and the holding frame extending from the second major surface to the distal end.

50. A holding frame according to claim 36, wherein the or each of said one or more cell-locating structure comprises a first diametrical dimension and a second diametrical dimension at its terminal edge, the second diametrical dimension being larger than the first diametrical dimension, thereby to provide the lead-in portion.

51. A holding frame according to claim 36, wherein the first portion comprises from 55% to 98% of the height of the upstanding wall, and the terminal portion comprises from 45% to 2% of the height of the upstanding wall and/or wherein the terminal portion is angled relative to the axis of the first portion, at an angle which is greater than zero and less than 60 degrees.

52. A battery pack assembly comprising two holding frames according to claim 36 and a plurality of cells, wherein said plurality of cells are located between a first and a second holding frames of said two holding frames.

53. A battery pack assembly according to claim 52, wherein the first major surface of the first frame faces the first major surface of the second frame, and wherein for a first of said cell-locating structures the distance between the first major surface of the first frame and the first major surface of the second frame is different to the distance between the first major surface of the first frame and the first major surface of the second frame for a second of said cell-locating structures.

54. A battery pack assembly, the assembly comprising a first holding frame and a second holding frame, a plurality of cells having terminals, and an electrically conductive conductor plate for providing electrical contact to at least two of said plurality of cells, the first holding frame having a first major surface and a second major surface, the first major surface having first and second cell-locating structures extending therefrom each of which are shaped and/or sized and/or configured to accommodate at least a portion of one of said plurality of cells, the second holding frame having a first major surface and a second major surface, the first major surface having first and second cell-locating structures extending therefrom each of which are shaped and/or sized and/or configured to accommodate at least a portion of said one of said plurality of cells, the distance between the facing first major surfaces of the first holding frame and the second holding frame being different for the respective first cell locating structures and second cell location structures.

55. A method for assembling a battery pack assembly, the method comprising:
i. providing a holding frame having a first major surface and a second major surface, on one or both of the first major surface and the second major surface the holding frame having one or more cell-locating structures which are shaped and/or sized and/or configured to accommodate at least a portion of one or more cells, the one or more cell-locating structures comprising a first wall upstanding from one of the first or second major surfaces, the first upstanding wall comprising a free or terminal portion which is shaped to provide a lead-in portion;
ii. locating a conductor plate on the holding frame;
iii. simultaneously locating a plurality of cells on the conductor plate by moving the cells past the lead-in portion of each cell-locating structure.
